(19) United States
(12) Patent Application Publication
(10) Pub. No.: US 2011/0111114 A1
(43) Pub. Date: May 12, 2011

(54) Grain-Based Powder

(75) Inventors: Victoria SpadaroGrant, Chicago, IL (US); Malcolm Thompson, Bangkok (TH); Kate Elizabeth Friend, Amsterdam (NL); Ter-Fung Tsao, Taipei (TW)

(73) Assignee: The Quaker Oats Company, Chicago, IL (US)

(21) Appl. No.: 13/009,945

(22) Filed: Jan. 20, 2011

Related U.S. Application Data
(62) Division of application No. 11/835,280, filed on Aug. 7, 2007.
Application No. 11/835,280 is a continuation of application No. 11/609,686, filed on Dec. 12, 2006, now abandoned.

(51) Int. Cl. A23L 1/10; A23L 1/30; A23L 2/38; A23L 1/302

(52) U.S. Cl. 426/622; 426/463

(57) ABSTRACT

A beverage composition comprising dry grain-based powder derived from a cereal mixture. The cereal mixture was cooked during manufacture without enzymes. When mixed with liquid, the dry grain-based powder forms a stable solution with little or no sedimentation for a sufficient duration of time for consumption.

This application is a continuation of U.S. patent application Ser. No. 11/609,686, filed Dec. 12, 2006, the disclosure of which is incorporated herein by reference.

### FIELD OF THE INVENTION

The present invention relates generally to food products. More specifically, the present invention relates to a grain-based powder.

### BACKGROUND OF THE INVENTION

Cereal food products are a staple of the human diet. Such cereal food products include, for example, oatmeal and grits. The nutritional value and health benefits of cereal food products, such as oatmeal, are well known and recognized. For example, oatmeal has been shown to reduce total cholesterol concentrations. Reducing cholesterol levels can decrease the probability of heart diseases or heart attacks. Manufacturers have developed cereal products having a wide range of shapes, flavors, colors, nutritional values, textures as well as form and preparation cereal products to appeal to a broad range of consumers.

With today's hectic lifestyle, consumers desire foods which are convenient and easy to eat “on-the-go”. Instant or ready-to-eat types of cereal products are currently available in the market which can be quickly prepared for eating. Preparation typically includes the addition of liquid into a bowl with the cereal and eating it with a spoon. The use of a bowl and spoon, however, makes such food products not conducive for eating on-the-go.

From the foregoing discussion, it is desirable to provide a cereal product which is easy and convenient to eat.

### SUMMARY OF THE INVENTION

The present invention relates to a dry cereal powder. In one aspect of the invention, the cereal powder is derived from a cereal mixture. Typically, the cereal mixture includes cereal mixed with water to form a slurry. The slurry is cooked without the addition of enzymes. When mixed with a liquid, the dry cereal powder forms a stable emulsion which can be consumed. The solution remains stable for a sufficient period of time to enable it to be consumed with little or no sedimentation of the powder. The dry cereal powder can be packaged, creating an instant type of cereal product which is prepared by the addition of a liquid. In another aspect of the invention, the dry cereal powder is mixed to form a cereal beverage.

In yet another aspect of the invention, a process for forming a food product is disclosed. The process includes providing a grain-based ingredient, e.g., ground oats or oat flour. The grain-based ingredient is mixed with a liquid to form a slurry which is cooked. Cooking the slurry is conducted without the use of enzymes. After cooking is completed, the cooked slurry is dried and milled to form a dry grain-based powder. When a liquid is added to the dry grain-based powder, the dry grain-based powder forms a stable solution when mixed with a liquid for a sufficient duration for consumption.

These and other aspects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a process for preparing a beverage in accordance with one embodiment of the invention;

FIG. 2 shows a process for manufacturing a grain-based powder in accordance to one embodiment of the invention;

FIG. 3 shows a process for manufacturing a grain-based powder in accordance with another embodiment of the invention; and

FIGS. 4a-d show results of an experiment conducted to determine stability of the grain-based beverages.

### DETAILED DESCRIPTION OF THE INVENTION

The present invention relates to food products. In particular, the present invention relates to dry grain-based powder. The grain-based powder can be used for various purposes. For example, the thy-grain powder can be mixed with a liquid to form a beverage or added to food products, including ready to eat foods or foods requiring preparation or cooking. The dry grain-based powder comprises cereal grain such as oat, wheat, corn (maize), rice, barley, millet, sorghum (milo), rye, triticale, teff, wild rice, spelt, buckwheat, amaranth, quinoa, kaniwa, cockscomb or a combination thereof. In one embodiment, the dry grain-based powder comprises whole oats, whole groats, or broken groats. Whole groats and broken groats can include rolled oats (old fashioned and instant types), cut oats and/or crushed oats. In one embodiment, the average particulate size of the dry grain-based powder is from about 150 μm to about 1200 μm, preferably 300, 400, 425, 475, 500 or 600 μm. In one embodiment, the cereal grain from which the grain-based powder is derived is cooked. The cooking, in one embodiment, is conducted without the use of enzymes such as amylase.

The dry grain-based powder can include beta glucan soluble fiber, such as beta-1,3-glucan, beta-1,6-glucan, or beta-1,4-glucan or mixtures thereof. In particular embodiments, the beta glucan is added, or is naturally present in the grain used to make the dry-grain based powder of the invention. Beta glucan is found in grains, including oats and in barley. In certain embodiments, the dry oat powder preferably contains at least about 3% to 5% or about 3.7% to 4% beta glucan. In certain embodiments, the dry oat powder containing powdered beverage product contains 0.1% to about 1.5% beta glucan, or about 0.8% to 1.3% beta glucan. Other amounts of beta glucan are also useful.

Additional ingredients may be added to the dry grain-based powder. Such ingredients can include non grain-based ingredients. For example, flavoring agents, coloring agents, sweeteners, salt, as well as vitamins and minerals can be included. In one embodiment of the invention, flavoring agents such as strawberry, chocolate or cinnamon flavor is added to enhance the taste of food product. Other fruit flavoring agent may also be useful to provide different tastes to the food product, for example, strawberry, mango and banana and mixtures thereof. Vitamins and minerals (e.g. vitamin E) can be included. Other types of fortification can be incorporated as well. Suitable sweeteners can be added in the food product to provide a desired sweetness. For example, brown sugar, maple sugar or fruit sugar can be used. The non-grain based food component can be added in the range of about 10 to 75 wt % of the total weight of the food product. Preferably, about 75 wt % of non-grain based food components are included in the food product. Other compositional ranges may also be useful.

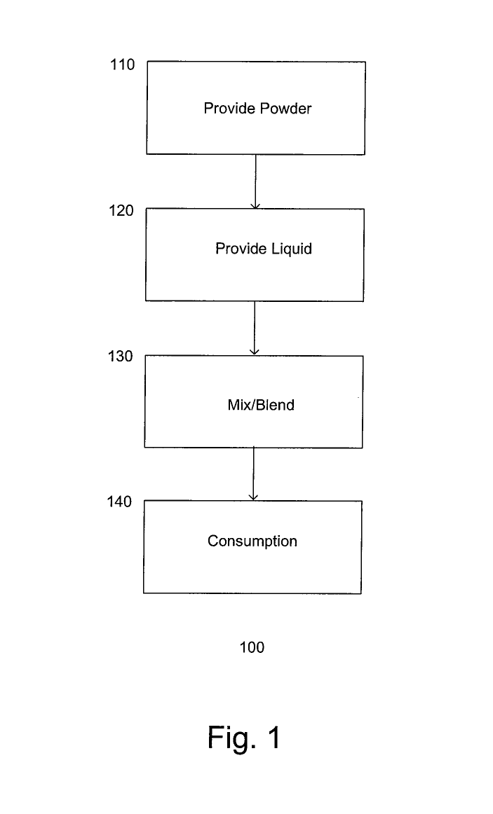

In one embodiment, the dry grain-based powder is used to prepare a beverage. FIG. 1 shows a process 100 for preparing a cereal beverage in accordance with one embodiment of the invention. To prepare the beverage, an appropriate amount of dry grain-based powder is provided at step 110. For a typical beverage, the dry powdered beverage powder contains about 20-30 wt % of dry grain-based powder, e.g., the oat component of the dry powdered beverage product is 20-30% of the total weight of the dry powdered beverage product. Preferably, about 25-27 wt % of dry grain-based powder of the total weight of the dry powdered beverage product is provided. Once added to a liquid, such as water, to produce the drinkable beverage, the grain content in preferred embodiments is from 3 to 5%, preferably 4% by weight of the drinkable beverage. Providing other percentages of powder/liquid is also useful, for example, depending on the desired viscosity, texture or mouthfeel. For example, a milk shake or frappe-like texture can be produced by adding a higher percentage of powder in the mixture.

Table 1 shows the composition of an individual serving of grain-based powder in accordance with one embodiment of the invention.

TABLE 1

| | Weight Per Serving |
|---|---|
| | (Serving Size of 8.0 g |
| | of cooked oats in |
| Ingredients | 250 ml liquid) |
| Beta Glucan | 0.3 g |
| Total Dietary Fiber | 0.76 g |
| Fat | 0.74 g |
| Protein | 0.98 g |

A liquid is added to the powder at step 120, forming a beverage solution. Various types of liquid can be added to the powder to form the beverage solution. For example, water, milk, soy milk, fruit juices, as well as other types of liquids such as coffee, and tea can be added. The liquid can be any temperature, preferably, the added liquid is preheated to, for example, 65° C. The powder can also be added to a combination of different liquids. The beverage can be formed having a desired temperature, depending on preference of the consumer. In one embodiment, a hot beverage is formed, similar to coffee or tea. Forming a non-heated beverage, such as a cold beverage is also useful. The non-heated beverage can be at about ambient temperature, refrigerated temperature or other temperatures.

To form the hot beverage, various techniques can be used. In one embodiment, a hot liquid is added to the powder to form the hot beverage. The temperature of the hot liquid can be about 65 to 95° C. In a preferred embodiment, the temperature of the liquid can be about 65° C. In one embodiment, the temperature of the hot liquid is about 95° C. Adding the liquid at a temperature below the desired temperature is also useful. In such case, the mixture can be heated after the powder has been added. Heating, in one embodiment, is achieved by injecting steam into the solution. A steamer, similar to that used for steaming milk in cappuccino machines, can be employed. Other techniques for heating the beverage, such as microwave oven, are also useful. Various techniques are also available for forming non-heated beverages. For example, a liquid having an ambient temperature can be added to the powder. Ice can be added to chill the beverage solution if a cooler temperature is desired. Also, ice can be used to form a beverage with frappe-like texture and mouthfeel.

At step 130, the combination of powder and liquid is mixed. Mixing should be sufficient to disperse the powder uniformly in the liquid. The mixing can be achieved by simple stirring of the solution with a stirrer or the like. Other mixing techniques can also be applied to form the beverage. For example, the solution can be shaken in a shaker or blended in a blender. The blender is particularly useful for mixing solutions with ice to form shake-like beverages. Steam can also be used to mix the solution. The steam can be used to agitate the solution, thereby dispersing the powder while heating the solution simultaneously. Once the solution is mixed, the beverage is ready to be consumed at step 140.

The dry grain-based powder, in accordance with the invention, when dispersed in a liquid remains stably dispersed. The powder should remain stably dispersed for sufficiently long duration to enable the beverage to be consumed. For example, the powder should remain stably dispersed for at least about 3 minutes. In one embodiment, the powder should remain stably dispersed for at least about 5 minutes. In another embodiment, the powder should remain stably dispersed for at least about 10 minutes. The powder preferably should remain stably dispersed for at least about 5-10 minutes. Dispersion stability, for example, relates to the powder remaining at least 85% dispersed in the solution. It has been found that by cooking the grain without the use of enzymes, a grain-based powder which can remain stably dispersed in liquid is unexpectedly produced.

As described, the present invention provides a healthy food product which is easy and quick to prepare while convenient to consume on-the-go, making it especially appealing to consumers with today's hectic lifestyle. The beverage can be prepared by the consumer or can be purchased at stores where beverages such as coffee are prepared and served.

The grain-based powder can be packaged and sold to consumers. Typically, the powder is packaged in bulk, containing numerous servings. Various bulk packaging sizes or number of servings can be provided, depending on different factors such as consumer demands or marketing strategy. For example, the bulk packaging can be provided in individual serve sachets of 30 to 35 grams. The filling can be conducted on vertical form fill seal equipment (or similar). The packaging film can be a laminate structure consisting of PET, PE, MPET and LLDPE. The sachets are either sold individually or packed into bags, pouches or cartons as multi-serve retail units. The product can also be packed in bulk as multi-serve packs. The size of the bags ranges from 300 grams to 3,000 grams. The filling is conducted on vertical form fill seal equipment (or similar). The packaging film will be a laminate structure consisting of PET, PE, MPET and LLDPE. The primary packaging is manufactured in a range of formats including pillow, pouch (with or without reclose fitments), block bottom and four-side sealed bags and bag-in-box formats depending on the market requirements. The primary laminate structure will consist of PET, PE, MPET and LLDPE. Bulk product can be shipped in rigid metal packaging or rigid multi-layer HDPE containers with an EVOH barrier. The size ranges from 250 grams to 3,000 grams and will include a closure that can be used to dispense the product as well as give protection from the environment. A measuring scoop can be included in the package for convenience. Other types of measuring devices are also useful. For example, the package can be provided with a dosing cap. The dosing cap is used to measure or dispense an appropriate amount of powder per serving size or other desired amounts. The dosing cap is particularly useful for mixing with liquid to form beverages.

In an alternative embodiment, the powder can be provided in individual serving size containers. A plurality of containers can be included in a product package. An individual serving comprises, for example, about 30 grams of grain-based powdered beverage which is to be mixed with about 250 ml of liquid. In a preferred embodiment, the 30 grams of grain-based powdered beverage comprises about 8 grams of dry powdered grain, e.g., oats. Other serving sizes are also useful. Individual-sized serving container provides convenience.

In one embodiment, an individual-sized container comprises a sachet. Other types of containers are also useful. For example, the single-serve container can be a shaker. Typically, the shaker is a cup-shaped container having a sufficient volume to hold a single serving of the beverage. Provided in the container is a single serving size of the powder and enclosed with a lid. A marker can be included to designate the amount of liquid to fill into the container. To prepare the beverage in the shaker, the lid is simply removed and liquid is added, followed by resealing with the lid and shaking the container to sufficiently mix the powder and liquid to form a cereal beverage.

The material used for the packets should be adequate to maintain its contents fresh for the duration of product's shelf-life. Freshness, here, relates to the retention of favorable sensory attributes, such as texture, flavor, appearance, including dryness. Freshness also reflects maintenance of a non-spoiled state of the grain-based powder while stored in the package. Typically, the packaging maintains the freshness of the grain-based cereal-based powder for about 7 months, about 6 to 10 months, about 10 to 12 months, or about 12 to 18 months. Various types of material, such as polymers, can be used to form the packaging. Table 2 provides examples of the materials used for packaging.

TABLE 2

| MANUFACTURER | PRODUCT | COMPOSITION |
|---|---|---|
| Exxon | 210 ASB-X | monoweb biaxially oriented |
| | | polypropylene (OPP) with |
| | | acrylic-coated outer layer and |
| | | PVDC-coated sealant layer |
| Pliant | Unipeel 354 | 3 mil, high density polyethylene |
| | | (HDPE)/HDPE/ethylene vinyl |
| | | acetate (EVA) |
| | Unilon 9420 | 3 mil HDPE/tie/HDPE/Nylon/ |
| | | tie/HDPE/low linear density |
| | | polyethylene (LLDPE) blend |
| | Unipeel 364 | 2.2 mil, HDPE/HDPE + |
| | | 2,6-di-t-butyl-4-methyl |
| | | phenol (BHT)/EVA |
| | X5:045A | 2.2 mil, polypropylene (PP)/PP/ |
| | | maleated PP (mPP) cast film |
| Bemis | — | 48 ga polyethyleneterephthalate |
| | | (PET)/adh/2.5 mil HDPE coex |
| | — | 48 ga PET/adh/3.0 mil HDPE coex |
| | — | 48 ga PET/1.5 mil HDPE coex |
| GPI | IQO Paper | 25# Natural Kraft/6# PVDC |
| | | (Saran)/9# PE |
| | RAR Kraft | 27.5# Natural Kraft/12# PVDC/12# PE |
| Printpak | — | 75 ga PET/ink/adh/3.5 mil HDPE |
| | | coex with metallocene |

A combination of these materials, and these materials at different thicknesses, can be used. Other types of materials, such as metal foils or glass, which can maintain the integrity of the grain-based powder for the duration of the shelf-life, are also useful.

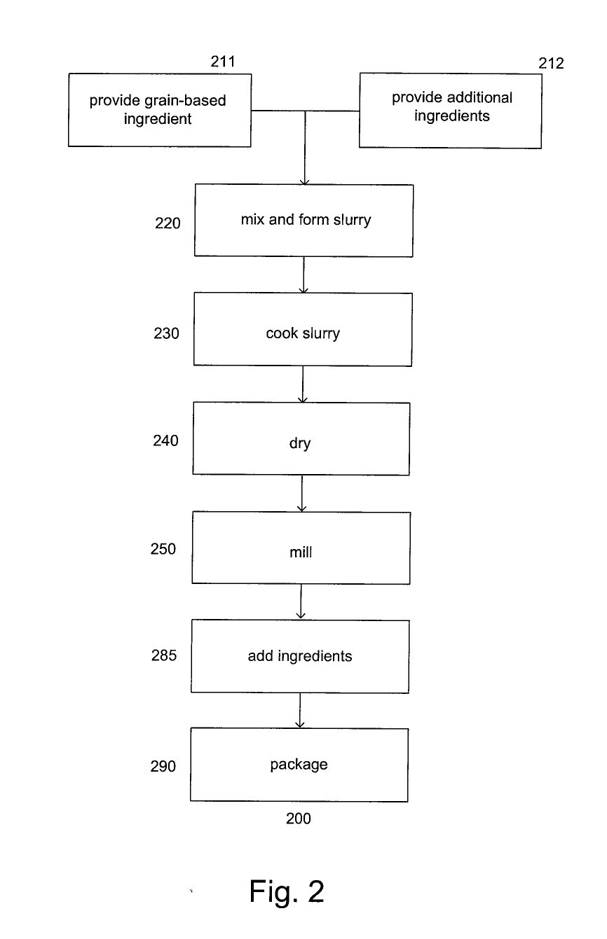

FIG. 2 shows a process 200 forming a beverage powder in accordance with one embodiment of the invention. The process includes providing a grain-based ingredient at step 211. The grain-based ingredient comprises, for example, cereal grain such as oat, wheat, corn (maize), rice, barley, millet, sorghum (milo), rye, triticale, teff, wild rice, spelt, buckwheat, amaranth, quinoa, kaniwa, cockscomb or a combination thereof . In one embodiment, the grain-based ingredient comprises oats, such as whole oats or groats. The oats can be rolled oats (old fashioned and instant types), cut oats or crushed oats. Preferably, the grain-based ingredient comprises ground groats or oat flour. One or more additional types of grains can also be included with the oats.

Additional ingredients can also be provided at step 212. The additional ingredients include, for example, non grain-based components. Non grain-based ingredients, such as sweeteners, salt, as well as vitamins and minerals can be provided. In particular embodiments, the additional ingredients are heat stable and not water soluble. Soluble fiber such as beta glucan, for example, beta-1,3-glucan, beta-1,6-glucan or beta-1,4-glucan or mixtures thereof can also be provided. Typically, the ratio of the grain-based and non-grain based ingredients is about 30/70, 25/75 or 47/53.

Since subsequent processing includes high temperature processes, such as cooking, the additional ingredients should be heat stable. Non-heat stable ingredients can be added after the high temperature processes. Alternatively, both heat and non-heat stable ingredients can be added after the high temperature processing.

At step 220, ingredients are mixed with liquid to form a slurry. In one embodiment, the ingredients are mixed with water. Other liquid may also be useful. Various types of mixer can be used to form the slurry. In one embodiment, a Triblender is used. The ingredients are sufficiently mixed to form a homogeneous slurry. Typically, the slurry comprises about 20-30 wt % ingredients of the total weight of the slurry.

The slurry is cooked at step 230. In one embodiment, the slurry is cooked by bringing it to 95-100° C. for about 30 minutes and then held at 85-90° C. for 90 minutes. In another embodiment, the slurry is cooked at 90 to 95° C. for about 30-90 minutes. In one embodiment, slurry is not cooked at a temperature that causes the liquid to boil, e.g., over 100° C. for water. Other cooking time and temperature may also be useful. Cooking should sufficiently gelatinize the slurry.

In accordance with the invention, cooking is conducted without enzymes. In conventional processes, enzymes are added in the cooking process to prevent the formation of starches. However, we have found that by not adding enzymes during cooking, the grain-based powder formed therefrom can be suspended in liquid with little or no separation. This produces a grain-based beverage in which grain-based powder is stably dispersed while the beverage is being consumed.

Cooking the slurry without enzymes prior to drying causes the resulting cereal beverage powder to release starch while in a hot liquid matrix, enabling the ingredients to suspend rather than separate in the liquid. As a result, a hot and high oat content beverage can be obtained later. The cooking of the slurry and no addition of any enzymes are critical for the minimal sedimentation once the beverage powder is reconstituted with liquid for consumption.

The cooked slurry is then dried at step 240. In one embodiment, the slurry is dried using drum drying techniques. Drum drying techniques are described in, for example, U.S. Pat. No. 3,492,667, the entire disclosure of which is incorporated herein by reference. Single or double drum dryers can be used. Preferably, double drum dryers are used. Other drying techniques, such as spray drying can also be used.

Generally, drum drying includes applying slurry to the surface of a heated drum as it is rotated. The hot surface serves to dry the slurry. The drying temperature is about 150 to about 170° C. In one embodiment, the drying is conducted at a pressure of 7.5-8 kg/cm². In one embodiment, the drum dryer has a nip gap of 1-2 mm. The drying substantially removes the water from the slurry. For example, the drying removes at least 90-98% or about 92% of the water from the slurry. The dried slurry forms a very thin grain-based sheet.

The dry sheet is pulverized at step 250 to form grain-based powder. In one embodiment, a mill can be used to form grain-based powder. Other methods for forming powder from the dried grain-based sheet are also useful. The particle density is, for example, from about 0.13-0.16 g/ml.

Additional ingredients of the dry grain-based powder which have not been previously added can be added at step 285. Such additional ingredients can include non-heat stable ingredients, e.g., skim milk powder, cocoa powder, vitamins, minerals, flavors, and colors. In one embodiment, flavoring or coloring agents are added to the grain-based powder. Flavoring agents can include, for example, strawberry, chocolate or cinnamon flavoring. Other types of flavoring agents or ingredients may also be added. The grain-based powder and the additional ingredients are blended. Various types of blenders, such as a ribbon blender, can be used.

The cereal beverage powder is then packed in consumer packaging at step 290. In one embodiment, the powder is bulk packaged. For example, the powder can be packaged in flexible bag or HDPE container. Preferably, the packaging system is air tight to avoid “fly away” pieces in the packaging area. The package, in one aspect, may include a scoop. Alternatively, single serve sampling pack in sachets and in a shaker may be useful. The shaker may be, for examples, made of HDPE. Preferably it is air tight and with suitable barrier properties. Such packaging is very useful as it provides convenience to the consumer, allowing consumers to consume the food product on-the-go.

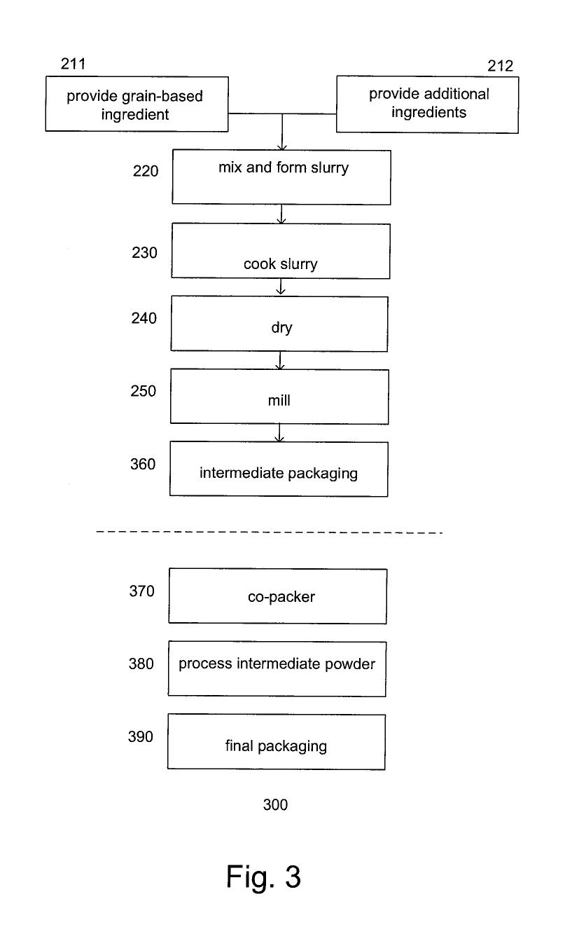

FIG. 3 shows an alternative process 300 for forming dry grain-based powder. The process from steps 211-250 is similar to those described in FIG. 2 and will not be described. After forming grain-based powder at step 250, intermediate packaging at step 360 is performed. Bulk containers are used to fill the powder. The intermediate packages are shipped to a co-packer at step 370. The grain-based powder is processed by the co-packer at step 380 and packed in consumer or final packaging at step 390. Steps 380 and 390 are similar steps of 285 and 290 in process 200 described in FIG. 2.

As described, the process is segmented into two separate segments. The primary segment forms an intermediate dry grain-based powder which is shipped to a co-packer for final processing and packaging.

### EXPERIMENT

An experiment was conducted to compare the stability of the grain-based powder in accordance with the invention with various conventional grain-based powders. Three samples A-C were prepared. Samples A, B and C comprise 100% oats dried in a drum dryer to a finished moisture content of 10%. Sample A is a dry powdered oat grain prepared according to the current invention. Sample B is a dry powdered oat grain prepared by hot cooking with enzyme followed by milling. Sample C is a Gerber product (Gerber Single Grain Oatmeal Cereal for Baby) that is believed to be hot cooked with enzyme followed by milling. The particle size and bulk density of samples A and B are as follows:

| | Product | |
|---|---|---|
| | A | B |
| Particle Size (μm) | % | % |
| 1180 | 0.5 | 0.0 |
| 850 | 6.7 | 0.6 |
| 710 | 9.0 | 1.6 |
| 425 | 38.2 | 18.7 |
| 300 | 22.7 | 23.6 |
| 150 | 22.2 | 34.9 |
| <150 | 1.3 | 20.9 |
| Bulk Density (g/ml) | 0.13 | 0.47 |

The samples of base components were added to hot water. In particular, 4 g of each sample was added to 100 ml of hot water at 95° C. The sample solutions were smoothly stirred to homogeneously disperse the base components. Each solution was stirred in the clockwise and then anticlockwise direction ten times for each direction. After stirring, the sample solutions were poured into 100 ml cylinders. The cylinders containing the samples were visually examined at various time intervals to determine the amount of base components which has separated from the water. The separated base components settle to the lower portion of the solution (e.g. sedimentation).

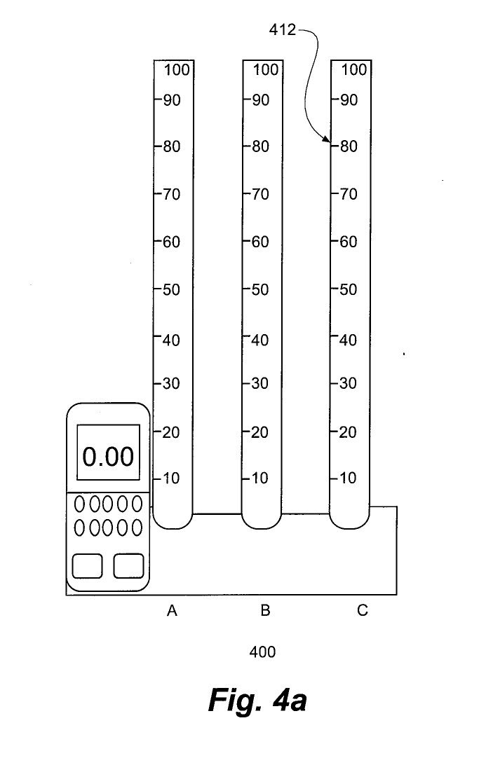

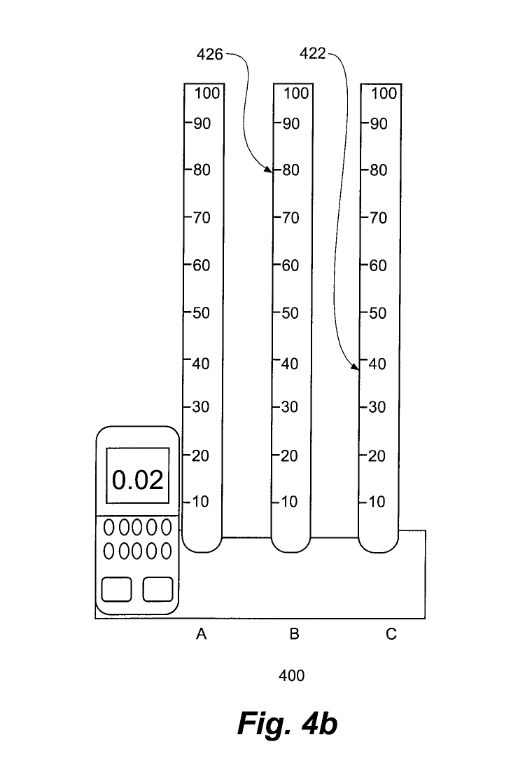

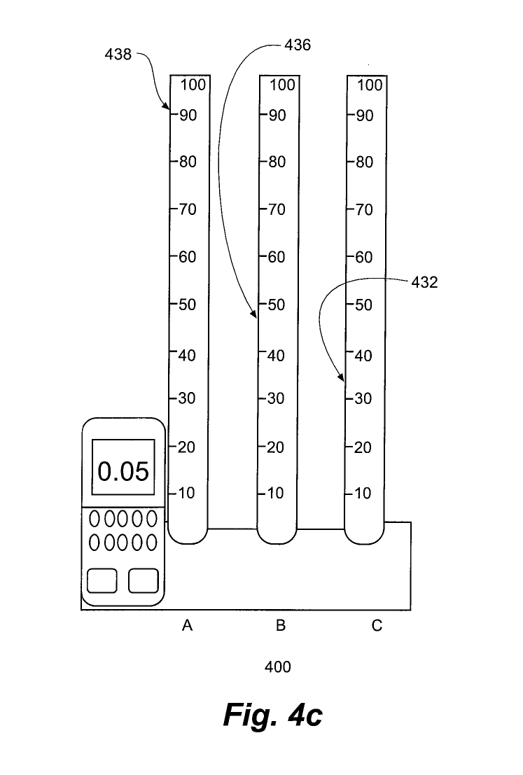

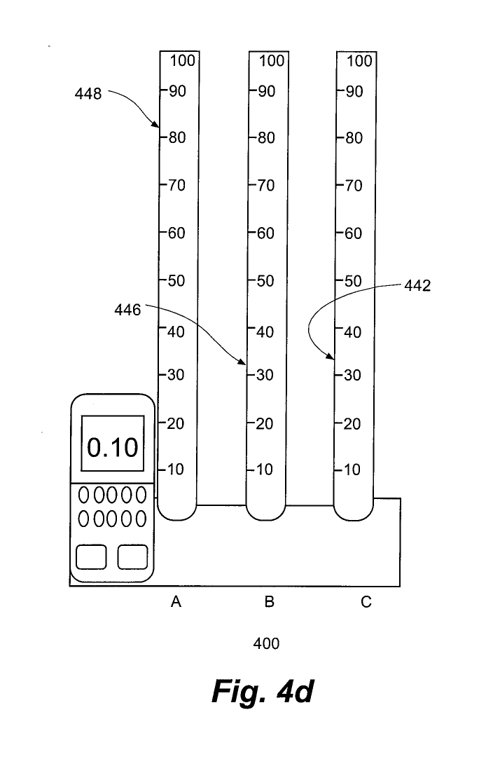

FIGS. 4a-d show results of the experiment at various time intervals. FIG. 4a shows cylinders filled with different sample solutions respectively at time interval=0 minutes. Even at time 0, sample C exhibits separation of the base component. In particular, sediment 412 is at about 85 cm. After 2 minutes, the sample B contains sediment 426 at about 85 cm and sample C contains sediment 422 at about 40 cm. Sample A, in contrast, shows no separation of the base component after 2 minutes. Referring to FIG. 4c, after 5 minutes, sediments 432 and 436 of samples B and C are respectively at about 50 cm and 35 cm while sample A shows small amount of sedimentation 438 at about 93 cm. After 10 minutes, sedimentations 442 and 446 of both samples B and C appear to be stabilized at about 35 cm while the sediment 448 of sample A is at about 85 cm. From the experiment, it is clear that grain-based powder derived from grain-based slurry that has been cooked without enzymes appears to remain stably dispersed in liquid, even after 10 minutes.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. (canceled)

2. A method of making a dry powdered grain based product, comprising the steps of:
obtaining a slurry comprising a cereal grain and water,
cooking the slurry,
drying the cooked slurry, and
milling the dried slurry to create the dry powdered grain based product;
wherein the dry powdered product comprises 20 to 30 wt% powdered oatmeal based on total weight of the dry powdered product.

3. The method of claim 2, wherein the method does not comprise the step of adding an enzyme to the slurry.

4. The method of claim 2, wherein the cooking is performed at a temperature of 100° C. or less.

5. The method of claim 2, wherein the drying is performed in a drum dryer.

6. (canceled)

7. (canceled)

8. The method of claim 2, further comprising the step of adding vitamin E.

9. (canceled)

10. The method of claim 2, further comprising the step of adding one or more of beta glucan, salt, hydrocolloids, polysaccharides, thickeners, artifical sweeteners, natural sweeteners, caffeine, dairy, coffee solids, tea solids, herbs nutraceutical compounds, electrolytes, vitamins, minerals, amino acids, preservatives, alcohol, colorants, emulsifiers, and oils.

11. (canceled)

12. (canceled)

13. A method of making a dry powdered grain based product, comprising the steps of obtaining a slurry comprising cereal grains and water, cooking the slurry, and drying the cooked slurry, wherein the method does not comprise the step of adding an enzyme to the slurry, and wherein the dry powdered product comprises 20 to 30 wt % powdered oatmeal based on total weight of the dry powdered product.

14. The method of claim 13, wherein the cooking is performed at a temperature of 100° C. or less.

15. The method of claim 13, wherein the drying is performed in a drum dryer.

16. The method of claim 13, wherein the cereal grain is oat.

17. The method of claim 2, wherein the cereal grain is selected from the group consisting of: oat, wheat, corn, rice, barley, millet, sorghum, rye, tritcale, teff, wild rice, spelt, buckwheat, amaranth, quinoa, kaniwa, and cockscomb.

18. The method of claim 2 wherein the dry powdered product comprises 25 to 27 wt % powdered oatmeal.

19. The method of claim 13 wherein the dry powdered product comprises 25 to 27 wt% powdered oatmeal.

20. A method of preparing a beverage comprising combining the dry powdered product produced by the method of claim 2 with water.

21. A method of preparing a beverage comprising combining the dry powdered product produced by the method of claim 13 with water.

22. The method of claim 20 further comprising combining 3 to 5% by weight of the dry powdered product with water.

23. The method of claim 21 further comprising combining 3 to 5% by weight of the dry powdered product with water.

24. The method of claim 2, wherein the average particle size of the dry powdered product is 150 μm to 1200 μm.

25. The method of claim 13, wherein the average particle size of the dry powdered product is 150 μm to 1200 μm.

26. The method of claim 2 wherein the dry powdered oat based product, when mixed with water, does not exhibit separation or sedimentation as measured by the steps of 1) adding about 4 g of the powdered oatmeal into 100 ml 95° C. water to create a mixture, 2) stirring the mixture, 3) pouring the mixture into a container, and measuring the sedimentation level.
